(19) United States
(12) Patent Application Publication
(10) Pub. No.: US 2023/0213746 A1
(43) Pub. Date: Jul. 6, 2023

(54) METHODS AND DEVICES FOR OPTIMIZING CONTRAST FOR USE WITH OBSCURED IMAGING SYSTEMS

(71) Applicant: NEWPORT CORPORATION, Irvine, CA (US)

(72) Inventors: Eliseo Ranalli, Irvine, CA (US); Patrick Vickroy, Irvine, CA (US)

(73) Assignee: Newport Corporation, Irvine, CA (US)

(21) Appl. No.: 18/008,878

(22) PCT Filed: Jul. 15, 2021
(86) PCT No.: PCT/US2021/041800

§ 371 Date: Dec. 7, 2022

Related U.S. Application Data
(60) Provisional application No. 63/054,931, filed on Jul. 22, 2020.

(51) Int. Cl. G02B 17/06; G02B 1/10; G02B 17/08; G02B 6/028

(52) U.S. Cl. CPC G02B 17/061; G02B 1/10; G02B 17/0808; G02B 6/0288; G02B 2207/101

(57) ABSTRACT

A system for outputting partially spatially coherent light to an imaging system is disclosed herein, which includes a spatially coherent light source configured to output a spatially coherent signal, at least one optical device having an optical device body with a first device surface formed thereon and configured to reflect a portion of the spatially coherent signal to form at least one coherent reflected signal. The optical device body also includes a second device surface having one or more surface irregularities configured to diffuse a portion of the spatially coherent light source output signal transmitted through the optical device body, to produce at least one spatially incoherent signal. The combination of the coherent reflected signal and the spatially incoherent signal form the partially spatially coherent light signal.

### CROSS-REFERENCE TO RELATED APPLICATIONS

The present application claims priority to U.S. Provisional Patent Application Ser. No. 63/054,931—entitled “Methods and Devices for Optimizing Contrast for Use with Obscured Imaging Systems”, filed on Jul. 22, 2020, the contents of which are incorporated by reference herein.

### BACKGROUND

Catoptric imaging systems are canonical optical design solutions for realizing optical objectives with large aberration-corrected fields over large wavelength ranges. FIGS. 1-3 show diagrams of various well-known prior art catoptric imaging systems commonly used. FIG. 1 shows a diagram of a prior art Cassegrain telescope 1 having a concave reflector 3 (primary mirror) and the convex reflector 5 (secondary mirror). During use, incoming light 7 is reflected from the concave reflector 3 to the convex reflector 5. Subsequently, the convex reflector 5 directs the reflected incoming light 7 through a light passage 9 formed in the concave reflector 3 to a focal point 11. In contrast, FIG. 2 shows a diagram of a Gregorian telescope 15 having a first concave reflector 17 (primary mirror) and second concave reflector 19 (secondary mirror). As shown, incoming light 21 is reflected by the first concave reflector 17 to the second concave reflector 19. The first mirror focal point 23 is formed between the first concave reflector 17 and the second concave reflector 19. The second concave reflector 19 reflects the incoming light 21 through a passage 25 formed in the first concave reflector 17 to a focal point 27. FIG. 3 shows a diagram of a typical Schwarzchild objective 31 having a first spherical reflector 37 (primary mirror) and a second spherical reflector 39 (secondary mirror). Incoming light 33 traverses through a light passage 35 formed in the first spherical reflector 37 and is incident on and reflected by the second spherical reflector 39 to the focal point 41.

While the systems shown in FIGS. 1-3 have proven successful in the past, a number of shortcomings have been identified for some applications. For example, a necessary consequence of such architectures is the resulting carving out of the incoherent modulation transfer function caused by the central obscuration. FIG. 4 graphically demonstrates the effects of a central obscuration (S₀/Sₘ) on the modulation transfer function (also referred to herein as “MTF”) wherein the number Vₒ represents the cutoff spatial frequency for a given numerical aperture (N.A.) and wavelength (A). As shown in FIG. 4, as the obscuration is increased, the degradation of the modulation transfer function is increased, particularly at mid-spatial frequencies. In contrast, while coherent illumination overcomes several of the shortcomings associated with the use of incoherent illumination in imaging systems having a large central obscuration, the use of coherent illumination for large central obscuration systems is limited. For example, the larger range of observable spatial frequencies associated with incoherent illumination tends to provide more information. In addition, coherent illumination tends to suffer from high-pass filtering of the imagery since the low spatial frequencies are filtered out.

In light of the foregoing, there is an ongoing need for methods and devices for optimizing contrast for use with obscured imaging systems.

### BRIEF DESCRIPTION OF THE DRAWINGS

The novel aspects of the methods and devices for optimizing contrast for use with obscured imaging systems as disclosed herein will be apparent by consideration of the following FIGS., wherein:

FIG. 1 shows a schematic diagram of an exemplary prior art Cassegrain telescope;

FIG. 2 shows a schematic diagram of an exemplary prior art Gregorian telescope;

FIG. 3 shows a schematic diagram of an exemplary prior art Schwarzchild objective;

FIG. 4 shows graphs of a modulation transfer function (MTF) for an aberration-free system for obscuration values;

FIG. 5 shows a schematic diagram of an embodiment of an imaging system incorporating an embodiment of a partially spatially coherent light system configured to deliver partially spatially coherent light to a focusing/objective system;

FIG. 6 shows planar cross-sectional view of the embodiment of the partially spatially coherent light system shown in FIG. 5;

FIG. 7 shows a cross-sectional view of an embodiment of the partially spatially coherent light system shown in FIG. 5 having partially spatially coherent light created therein;

FIG. 8 shows a schematic diagram of an embodiment of an imaging system incorporating an embodiment of a mode scrambling system configured to generate partially spatially coherent light;

FIG. 9 shows a schematic diagram of an embodiment of a spatially coherent light source coupled to an embodiment of a mode scrambling system for use in the embodiment of the imaging system shown in FIG. 8;

FIG. 10 shows a schematic diagram of an embodiment of catadioptric focusing/objective system for use in the various embodiments of the imaging systems disclosed herein;

FIG. 11A shows a representation of the 2D optical transfer function magnitude of an imaging system utilizing spatially coherent light as an illumination source;

FIG. 11B shows a representation of the 2D optical transfer function magnitude of an imaging system utilizing spatially incoherent light as an illumination source;

FIG. 11C shows a representation of the 2D optical transfer function magnitude of an imaging system utilizing partially spatially coherent light as an illumination source;

FIG. 12A shows a graph representing a cross-section of the 2D optical transfer function magnitude of an imaging system utilizing spatially coherent light as an illumination source;

FIG. 12B shows a graph representing a cross-section of the 2D optical transfer function magnitude of an imaging system utilizing spatially incoherent light as an illumination source;

FIG. 12C shows a graph representing a cross-section of the 2D optical transfer function magnitude of an imaging system utilizing partially spatially coherent light as disclosed in the present application as the illumination source;

FIG. 13A shows a representation of the resolution of a USAF target section having a height of 0.2 μm when the target is illuminated with spatially coherent light;

FIG. 13B shows a representation of the resolution of a USAF target section having a height of 0.2 μm when the target is illuminated with spatially incoherent light;

FIG. 13C shows a representation of the resolution of a USAF target section having a height of 0.2 μm when the target is illuminated with partially spatially coherent light using the imaging system disclosed herein;

FIG. 14A shows a representation of a 40 pair per revolution spoke target of image height 0.5 mm when the target is illuminated with spatially coherent light;

FIG. 14B shows a representation of a 40 pair per revolution spoke target of image height 0.5 mm when the target is illuminated with spatially incoherent light; and

FIG. 14C shows a representation of a 40 pair per revolution spoke target of image height 0.5 mm when the target is illuminated with partially spatially coherent light using the imaging system disclosed herein.

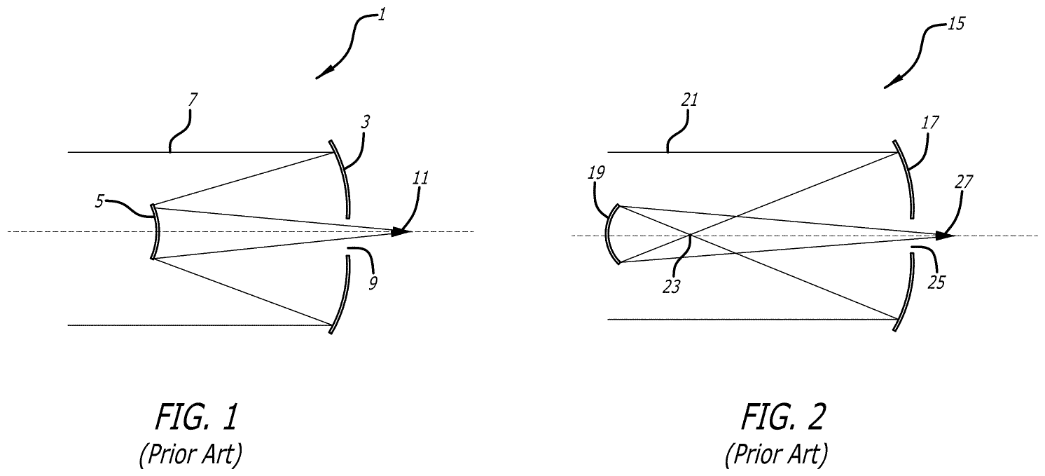

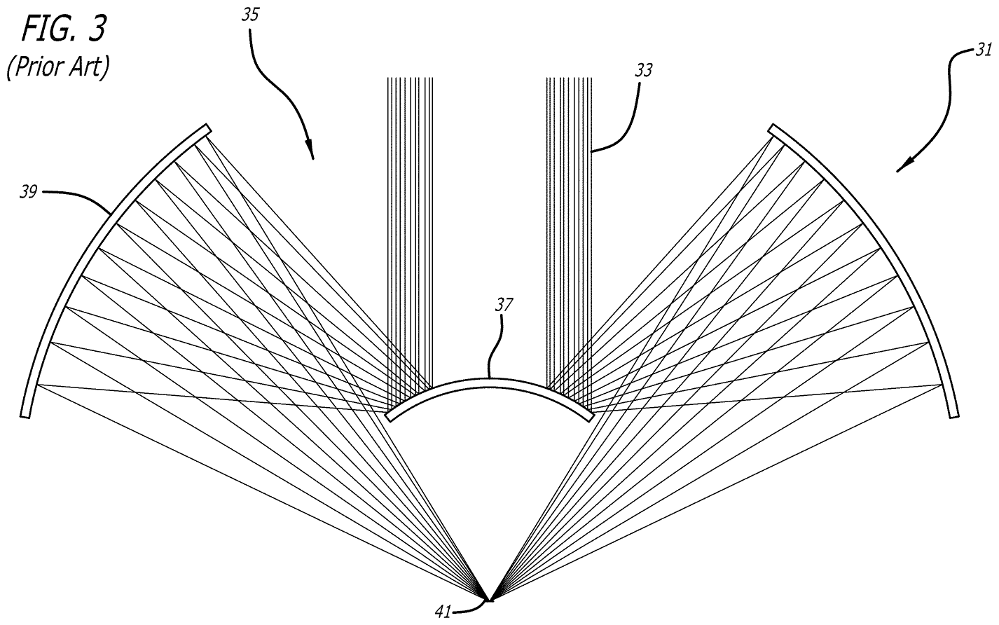

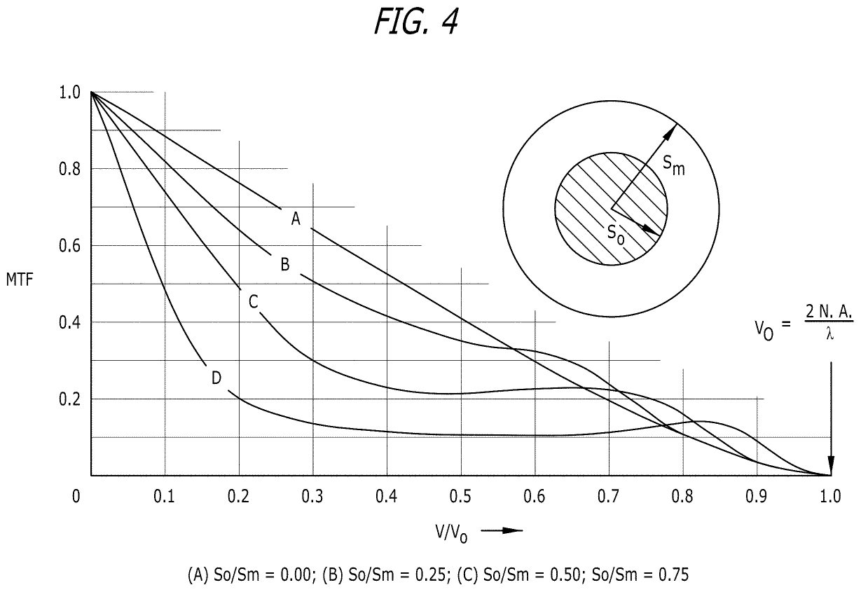

### DETAILED DESCRIPTION

The present application discloses various embodiments of methods and devices for optimizing contrast for use with obscured imaging systems. In some applications, various embodiments disclosed herein may be used in imaging systems which include one or more large obscuration objectives. In the alternative, the various embodiments disclosed herein may be used in any variety of optical systems wherein partially spatially coherent light is desired. For example, various embodiments disclosed herein may be used with any variety of optical systems which include one or more large obscuration objectives, telescopes, and the like.

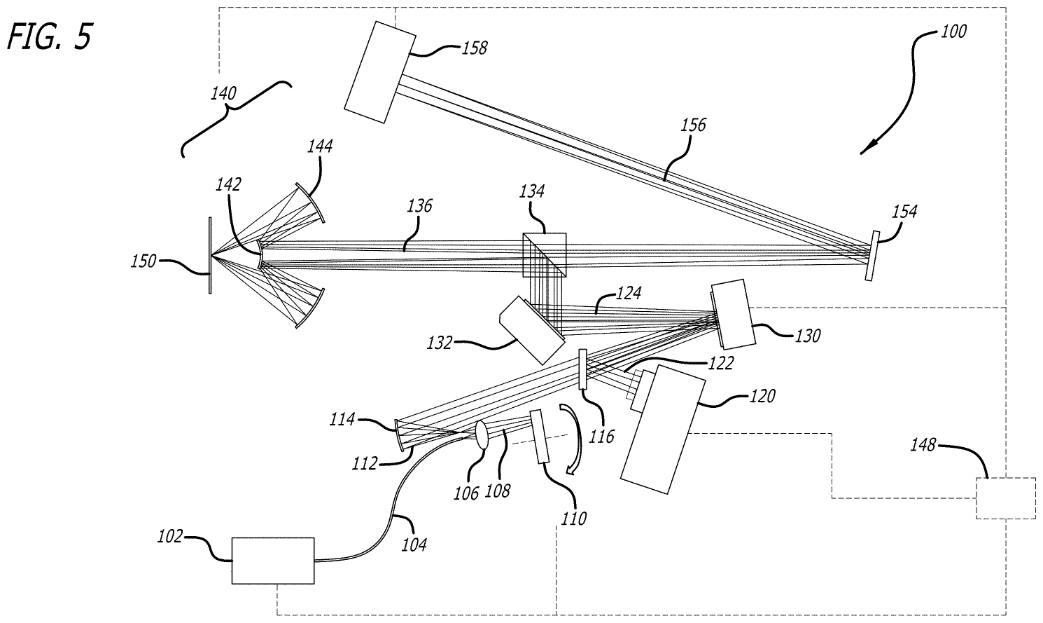

FIGS. 5-7 show an embodiment of an imaging system which includes at least one system for generating partially spatially coherent light (hereinafter PSCL). As shown, the imaging system 100 includes at least one light source 102. Exemplary light sources 102 include, for example, lasers, laser diodes, laser-driven light sources, super luminescent LEDs, laser diodes, amplified spontaneous emission sources, supercontinuum light sources, broadband light sources configured to couple to one or more optical fibers, plasma sources, arc devices, and the like. Further, one or more optical fibers 104 may be coupled to or otherwise in optical communication with the light source 102. The optical fiber 104 may be configured to deliver at least one spatially coherent light source output signal 108 from the light source 102 to the various elements of the imaging system 100. In one embodiment, the optical fiber 104 comprises a single mode optical fiber. Optionally, the optical fiber 104 may comprise a multimode optical fiber. Exemplary optical fibers include, without limitations, single mode fibers, endlessly single mode fibers, photonic crystal fibers, optical crystal fibers, holey fibers, multimode fibers, and the like. In another embodiment, the imaging system 100 need not include an optical fiber 104.

Referring again to FIG. 5, at least one lens 106 may be used within the imaging system 100 to focus or otherwise modify at least a portion of the spatially coherent light source output signal 108 transmitted from the light source 102. In the illustrated embodiment, the lens or optical element 106 may be configured to focus the spatially coherent light source output signal 108 of the light source 102 from the optical fiber 104. Optionally, any variety of optical elements may be used in addition to or instead of the lens 106, including, without limitation, lens systems, stops, beam splitters, sensors, filters, gratings, irises, and the like. In another embodiment, the imaging system 100 need not include the lens 106. Further, in yet another embodiment, the lens 106 may be incorporated into and/or coupled to the optical fiber 104.

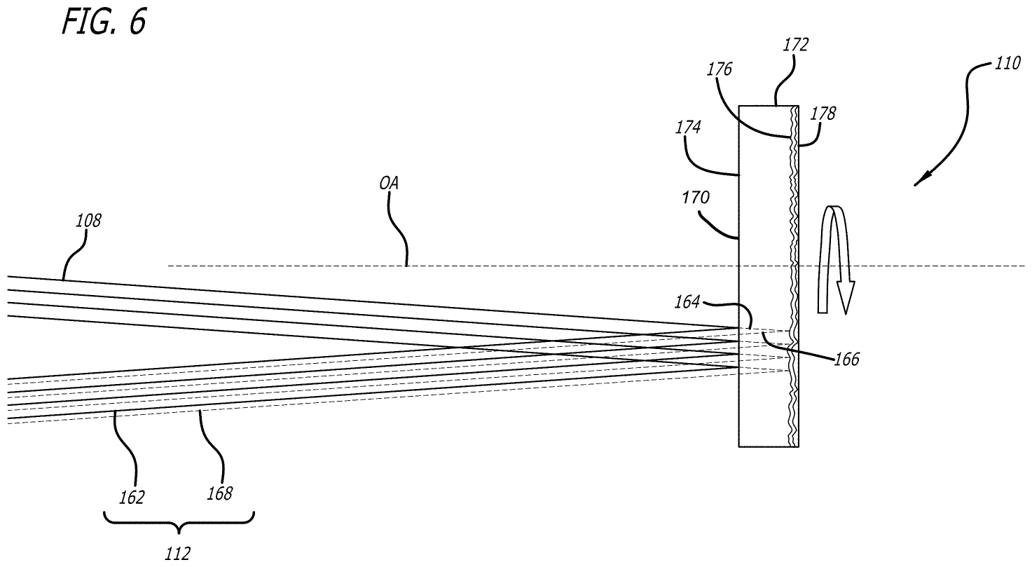

As shown in FIGS. 5-7, the spatially coherent light source output signal 108 may be focused by the lens 106 onto at least one system for producing partially spatially coherent light 110 (hereinafter PSCL system 110). As shown in FIGS. 6 & 7, the PSCL system 110 includes an optical device 170 having an optical device body 172 having a first device surface 174 and at least a second device surface 176. In the illustrated embodiment the optical device body 172 of the PSCL system 110 comprises a glass or silica-based material disk configured to rotate about an optical axis OA. Optionally, the optical device body 172 may be manufactured from any variety of materials including, without limitation, optical crystals, composite materials, ceramic materials, and the like. Further, those skilled in the art will appreciate that the optical device body 172 may be manufactured in any variety of shapes and/or configurations. In one embodiment, the optical device body 172 comprises the first device surface 174 having a flat, planar surface and a second device surface 176 having one or more surface irregularities or diffusing features/materials formed thereon or coupled thereto. In addition, the second device surface 176 includes at least one reflective coating 178 (reflectivity greater than about 99.5%) applied thereto. In one embodiment, the first device surface 174 includes at least one optical coating (not shown) applied thereto. Optionally, the first device surface 174 and the second device surface 176 may include at least one optical coating applied thereto. As shown, during use, the spatially coherent light source output signal 108 from the light source 102 is directed into the optical device body 172 by the lens 106. A portion of the spatially coherent light source output signal 108 is reflected by the first device surface 174 of the PSCL system 110 to form at least one coherent reflected signal 162 having a coherent power η. Further, at least a portion of the spatially coherent light source output signal 108 is refracted by the optical device body 172 and traverses through the optical device body 172 and forms at least one refracted signal 164 therein. The refracted signal 164 is incident on one or more surface irregularities formed on the second device surface 176 and is reflected by the reflective coating 178 applied to the second device surface 176 to form at least one reflected-refracted signal 166. In one embodiment, the coating 178 may have the same morphology (e.g., having the same surface irregularities) as the second device surface 176. In another embodiment, the coating 178 may be planar, without the same surface irregularities as the second device surface 176. The reflected-refracted signal 166 traverses back through the optical device body 172 of the PSCL system 110. The reflected-refracted signal 166 is emitted through the first device surface 174 of the optical device body 172 to form at least one spatially incoherent signal 168 having an incoherent power (1−η)². In one embodiment, substantially all of the reflected-refracted signal 166 is emitted from the first device surface 174.

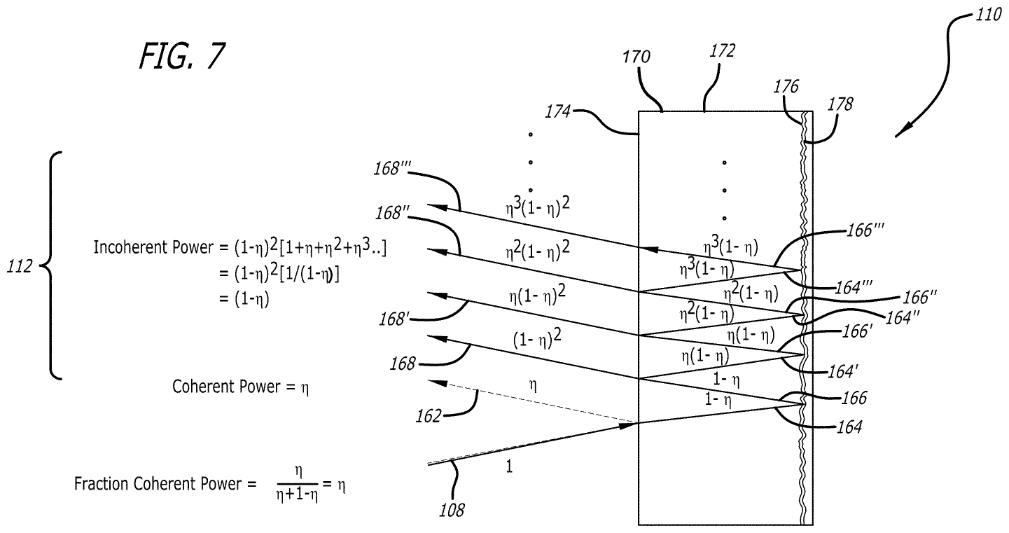

Referring again to FIGS. 6 and 7, any portion of the reflected-refracted signal 166 that is internally reflected by the first device surface 174 of the optical device body 172 of the PSCL system 110 forms a second refracted signal 164′ which traverses through the optical device body 172. The second refracted signal 164′ is reflected by the second device surface 176 to form a second reflected-refracted signal 166′, a portion of which is emitted from the first device surface 174 to form at least a second spatially incoherent signal 168′ having a second incoherent power η(1−η)². This sequence of reflected/refracted signals traversing through the optical device body 172 and the emission of incoherent signals from the PSCL system 110 continues, eventually culminating with emission of the spatially incoherent signal 168′″ having an incoherent power of η³(1−η)², although those skilled in the art will appreciate that the sequence of reflected/refracted signals traversing through the optical device body 172 and the emission of spatially incoherent signals from the PSCL system 110 may continue for any number of sequences. As shown in FIGS. 6 and 7, the PSCL light 112 is formed from the mixing of the coherent reflected signal 162 and the multiple spatially incoherent signals 168 output from the PSCL system 110. For example, in one embodiment, the PSCL light 112 may comprise a mixture of coherent light and incoherent light. More specifically, in one embodiment, the PSCL light 112 comprises about 20% to 30% coherent light and about 70% to 80% incoherent light. In another embodiment, the PSCL light 112 comprises about 30% to 40% coherent light and about 60% to about 70% incoherent light. Optionally, the PSCL light 112 may comprise about 40% to about 50% coherent light and about 50% to about 60% of incoherent light. In one specific embodiment, the at least PSCL light 112 comprises about 43% coherent light in about 57% incoherent light, although those skilled in the art will appreciate that any ratio of coherent light to incoherent light may be used to form the at least one PSCL light 112.

As shown in FIG. 5, the PSCL light 112 may be directed to one or more reflectors and/or mirrors by the lens 106. The reflectors and/or mirrors may be configured to direct at least a portion of the PSCL 112 light to at least one focusing/objective system 140. For example, in the illustrated embodiment the PSCL light 112 is directed by at least one mirror 114 to one or more selectively movable mirrors. In the illustrated embodiment, the imaging system 100 includes a first galvo/scanning mirror 130 and a second galvo/scanning mirror 132 in communication with the mirror 114. Those skilled in the art will appreciate that any number of selectively movable mirrors and/or stationary mirrors may be used in the imaging system 100. In the illustrated embodiment, the first galvo/scanning mirror 130, second galvo/scanning mirror 132, and/or mirror 114 comprise planar reflectors. Optionally, the first galvo/scanning mirror 130, second galvo/scanning mirror 132, and/or mirror 114 may comprise curved mirrors. As such, at least one controller 148 may be in communication with at least one of the first galvo/scanning mirror 130, the second galvo/scanning mirror 132, or both. Optionally, the imaging system 100 need not include reflectors and/or mirrors therein. Further, the imaging system 100 need not include a controller 148.

Referring again to FIG. 5, the imaging system 100 includes at least one autofocus module 120 configured to generate at least one autofocus signal 122. As shown, the autofocus signal 122 emitted from the autofocus module 120 may be inserted into the beam path of the PSCL light 112 by at least one optical element/beam combiner 116, thereby creating at least one auto-focused partially spatially coherent signal 124 which is incident upon at least one of the first galvo/scanning mirror 130, the second galvo/scanning mirror 132, or both. During use, the autofocus signal 122 may be configured to permit selective control, focusing, and/or positioning of the auto-focused partially coherent signal 124 within the imaging system 100. As such, the autofocus module 120 may be in communication with the controller 148.

As shown in FIG. 5, the auto-focused partially coherent signal 124 may be incident upon one or more beam splitters 134 positioned within the imaging system 100. In the illustrated embodiment, the beam splitter 134 may be configured to direct at least a portion of the auto-focused partially coherent signal 124 to at least one focusing/objective system 140 thereby forming at least one imaging system output signal 136. In the illustrated embodiment, the focusing/objective system 140 includes a first focusing reflector 142 and at least a second focusing reflector 144 in optical communication with the first focusing reflector 142, the first and second focusing reflectors 142, 144 configured to focus the imaging system output signal 136 onto at least one substrate 150. Although the embodiment illustrated in FIG. 5 shows a Schwarzchild objective, those skilled in the art will appreciate that the focusing/objective system 140 may comprise any variety of focusing and/or objective systems. In one embodiment, the focusing/objective system 140 includes a central obscuration with large aberration-corrected fields over large wavelength ranges. Those skilled in the art that the focusing/objective system 140 need not include a central obscuration. As such, any variety or types of focusing/objective system 140 may be used with the present system.

Referring again to FIG. 5, the imaging system 100 may include at least one camera and/or sensor 158 configured to monitor at least one optical characteristic of the auto-focused partially coherent signal 124 within the imaging system 100. As shown, the camera 158 is in communication with the beam splitter 134 via at least one reflector 154. During use, the beam splitter 134 directs at least a portion of the auto-focused partially coherent signal 124 to the camera 158, thereby forming at least one sample signal 156. Like the galvo/scanning mirrors 130, 132, the camera 158 may be in communication with the controller 148, thereby permitting the user to selectively monitor and control at least one optical characteristic of the auto-focused partially coherent signal 124. Similarly, the PSCL system 110 may be in communication with the controller 148. Optionally, the focusing/objective system 140 may include one or more movable stages (not shown). As such, various elements of the focusing/objective system 140 may be in communication with the controller 148 allowing selective control of the focusing characteristics of the focusing/objective system 140.

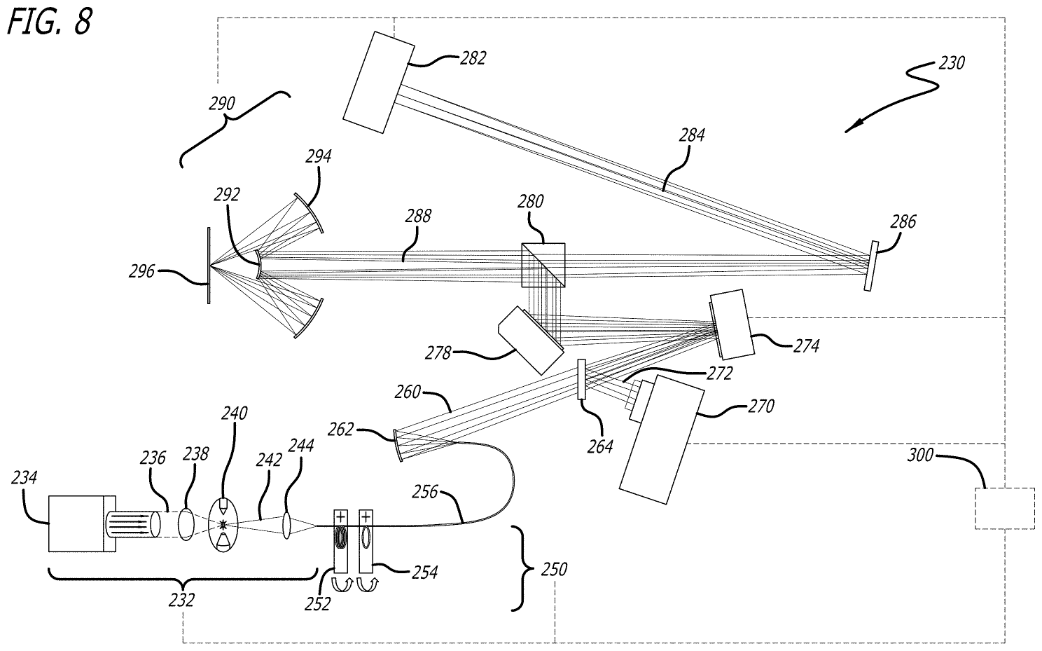

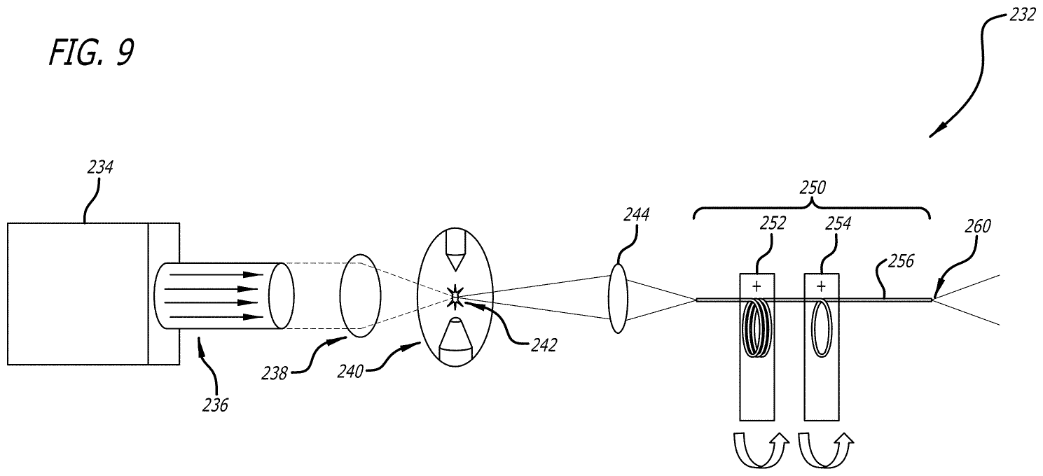

FIGS. 8 and 9 show various views of an alternate embodiment of an imaging system which includes at least one partially coherent light system therein. As shown, the imaging system 230 includes at least one light source system 232. In one embodiment, the light source system 232 comprises at least one light source 234 configured to output at least one light source output signal 236 such as a laser-driven light source. Optionally, the light source 234 may comprise any variety of light sources including lasers, laser diodes, super luminescent LEDs, laser diodes, amplified spontaneous emission sources, supercontinuum light sources, or broadband light sources configured to couple to one or more optical fibers, plasma sources, arc devices, and the like.

As shown in FIGS. 8 and 9, at least one optical element 238 may be used to modify or otherwise condition the light source output signal 236. In the illustrated embodiment, the optical element 238 comprises a lens configured to focus the light source output signal 236 into at least one plasma envelope, arc envelope, or lamp 240 configured to generate at least one broadband coherent optical signal 242. In one embodiment, the broadband coherent optical signal 242 has a wavelength range from about 150 nm to 750 nm or more. Optionally, the imaging system 230 need not include the lamp 240 provided that the light source 234 is configured to output a light source output signal 236 having a wavelength range from about 150 nm to about 750 nm or more. Optionally, the outputs of multiple light sources 234 may be combined and used provide a light source output signal 236 having a wavelength range from about 150 nm to 750 nm or more.

Referring again to FIGS. 8 and 9, the broadband coherent optical signal 242 may be directed into at least one optical fiber 256 by one or more lenses or optical elements 244. In the illustrated embodiment, a single lens is used to focus the broadband output signal 242 into the optical fiber 256, although those skilled in the art will appreciate any number of lenses, optical elements, stops, irises, filters, gratings, and the like may be used anywhere within the imaging system 230. In one embodiment, the optical fiber 256 comprises at least one multimode optical fiber. In another embodiment, the optical fiber 256 comprises at least one single mode optical fiber, endless single mode fibers, photonic crystal fibers, optical crystal fibers, holey fibers, and the like. In the illustrated embodiment, the optical fiber 256 includes at least one mode scrambling system 250 formed therein. For example, as shown in FIGS. 8 and 9, the optical fiber 256 includes a first mode scrambling body 252 and at least a second mode scrambling body 254 formed therein. In one embodiment, at least one of the first mode scrambling body 252 and second mode scrambling body 254 comprise one or more loops and/or rings of optical fiber. As such, the mode scrambling system 250 may operate as a time-varying mode scrambler configured to reduce or eliminate speckle.

As shown in FIG. 8, the optical fiber 256 outputs at least one mode scrambled output signal 260. One embodiment, the mode scrambled output signal 260 comprises PSCL light. For example, in one embodiment, the mode scrambled output signal 260 may comprise a mixture of coherent light and incoherent light. More specifically, in one embodiment, the mode scrambled output signal 260 comprises about 20% to 30% coherent light and about 70% to 80% incoherent light. In another embodiment, the mode scrambled output signal 260 comprises about 30% to 40% coherent light and about 60% to about 70% incoherent light. Optionally, the mode scrambled output signal 260 may comprise about 40% to about 50% coherent light and about 50% to about 60% of incoherent light. In one specific embodiment, the at least one mode scrambled output signal 260 comprises about 43% coherent light and about 57% incoherent light, although those skilled in the art will appreciate that any ratio of coherent light to incoherent light may be used to form the at least one mode scrambled output signal 260. Like the previous embodiment, one or more mirrors and/or reflectors may be used within the imaging system 230. Optionally, the mirrors and/or reflectors may comprise planar or curved mirrors. In the illustrated embodiment, at least one mirror 262 configured to direct at least a portion of the mode scrambled optical signal 260 to at least one steering mirror or selectively movable mirror. Like the previous embodiment, the imaging system 230 includes a first galvo/scanning mirror 274 and a second galvo/scanning mirror 278, although those skilled in the art will appreciate any number of galvo/scanning mirrors may be used. In addition, the imaging system 230 shown in FIG. 8 may include at least one autofocus module 270 configured to output at least one autofocus signal 272. In one embodiment, the autofocus signal 272 may be inserted into the optical train via at least one optical element 264 positioned within the imaging system 230. As shown, the optical element 264 may be positioned between mirror 262 and the first galvo/scanning mirror 274. Optionally, the optical element 264 may be positioned anywhere within the imaging system 230. During use, the optical element 264 may be configured to combine the autofocus signal 272 with the mode scrambled signal 260 to form an autofocus mode scrambled signal 288.

Referring again to FIG. 8, at least one beam splitter 280 may be used to direct at least a portion of the autofocus mode scrambled signal 288 to at least one focusing/objective system 290, thereby forming at least one sample optical signal 284. As shown in FIG. 8, the focusing/objective system 290 includes a first reflector 292 and at least a second reflector 294 configured to focus the autofocus mode scrambled signal 288 onto a substrate or specimen 296.

In addition, the beam splitter 280 may be configured to direct at least a portion of the sample optical signal 284 to at least one camera, sensor, or similar device 282. In one embodiment, at least one mirror 286 may be used to direct the sample optical signal 284 to the camera 282. Like the previous embodiment, the imaging system 230 may include one or more controllers or processors 300 in communication with at least one component or element used the imaging system 230. For example, in one embodiment, the controller 300 is in communication with the camera 282. Optionally, the controller 300 may be in communication with the light source system 232, the mode scrambling system 250, the autofocus module 270, the first galvo/scanning mirror 274, the second galvo/scanning mirror 270, the focusing/objective system 290, and/or the camera 282 permitting the user to selectively monitor and control the performance of the imaging system 230. Further, the controller 300 may be in communication with one or more external networks (not shown).

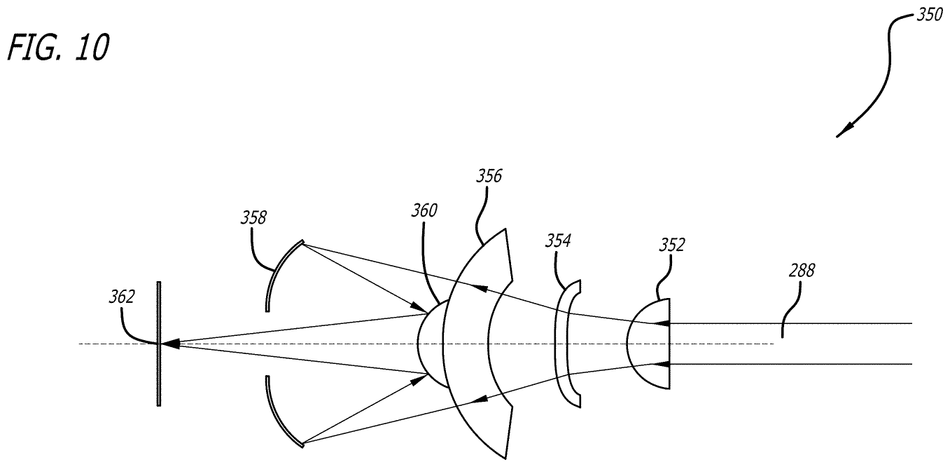

FIG. 8 shows an embodiment of an imaging system which again includes at least one focusing/objective system 290. As shown, similar to the focusing/objective system 140 shown in FIG. 5, the focusing/objective system 290 utilizes a first reflector 292 and at least a second reflector 294 focus the autofocus mode scrambled signal 288 onto a sample, substrate, and/or specimen 296. In contrast, FIG. 10 shows an alternate embodiment of a focusing/objective system 350 configured for use with the imaging systems 100, 230 shown in FIGS. 5 and 8, respectively. As shown, the focusing/objective system 350 includes one or more refractive optical devices or elements in addition to the reflective elements shown in the focusing/objective system 140, 290 shown in FIGS. 5 and 8. As such, the imaging systems disclosed herein may be configured to employ one or more catadioptric focusing/objective systems. In one embodiment, the focusing/objective system 350 shown in FIG. 10 includes a first refractive optic 352, a second refractive optic 354, and the third refractive optic 356. Those skilled in the art will appreciate any number of reflective or refractive optics may be used in the focusing/objective system 350. The autofocus mode scrambled signal 288 traverses through the first, second, and third refractive optics 352, 354, 356, and is incident on the first reflector 358. The first reflector 358 directs the autofocus mode scrambled signal 288 to the second reflector 360, which directs the autofocus mode scrambled signal 288 onto a specimen or sample 362. Those skilled in the art will appreciate that any number of reflective or refractive optics elements may be used in the focusing/objective system 350. In addition, any variety of additional optical elements maybe included in the focusing/objective system 350 including, without limitation, stops, gratings, irises, filters, sensors, and the like.

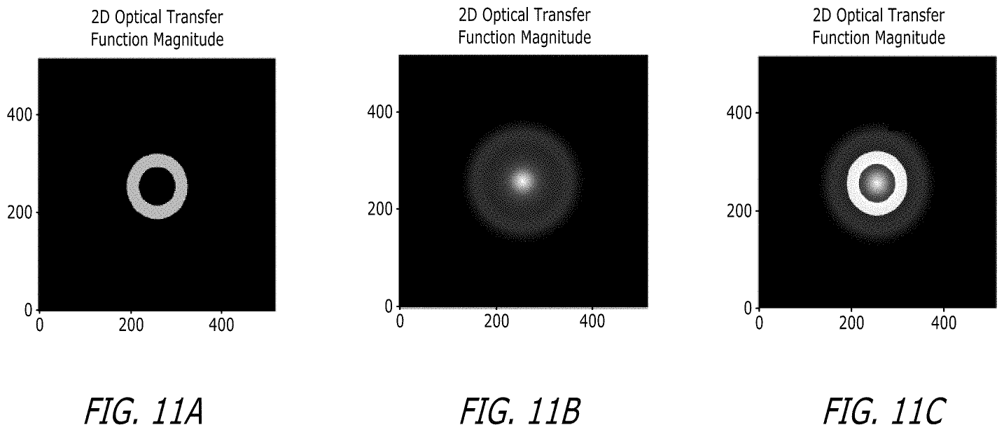

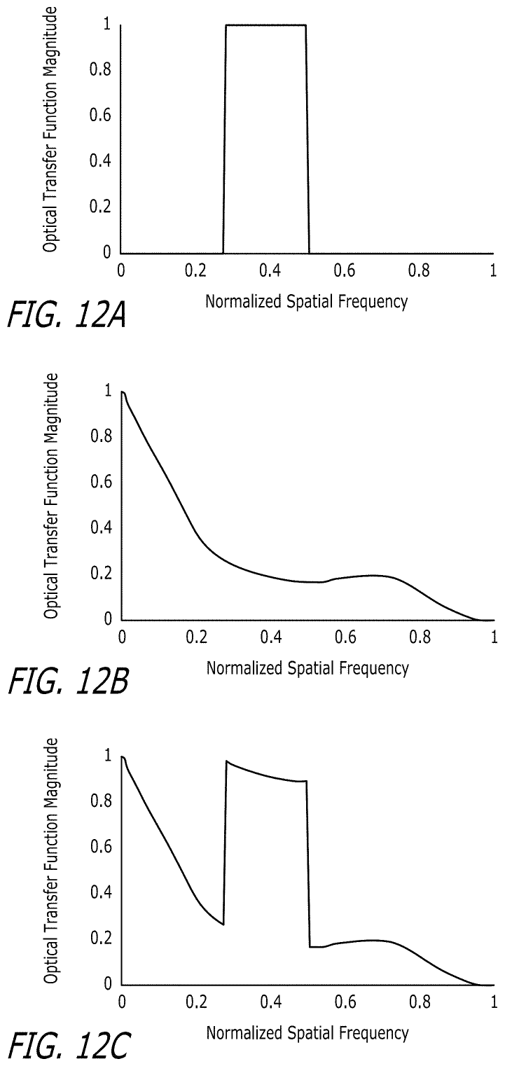

FIGS. 11A-13C show various representations of the performance of the imaging systems shown in FIG. 8 using a spatially coherent light source, a spatially incoherent light source, and partially spatially coherent light produced using the embodiments described above. FIGS. 11A and 12A show the optical transfer function response of the imaging system shown in FIG. 8 using spatially coherent illumination. More specifically, FIGS. 11A and 12A show the magnitude of 2-D response and corresponding cross-section for positive spatial frequencies, respectively, with the radius of the outer ring corresponding to one half the cutoff frequency, or a normalized radius of 0.5, yielding 0.47 bits at SNR=50 over cutoff-resolved spot. In contrast, FIGS. 11B and 12B show the corresponding response of the imaging system shown in FIG. 8 using incoherent illumination which yields 1.38 bits at SNR=50 over cutoff-resolved spot. As shown, there is objectively more information in the intensity measurement of the resolved spot with incoherent illumination. However, many optical designers would consider their response inferior to that for coherent illumination due to the relatively low modulation transfer function (about 17%) at half cutoff. FIGS. 11C and 12C show the corresponding optical transfer function characteristics for an optimized partially spatially coherent light produced using the mode scrambling system 250 described above and shown in FIGS. 8 and 9.

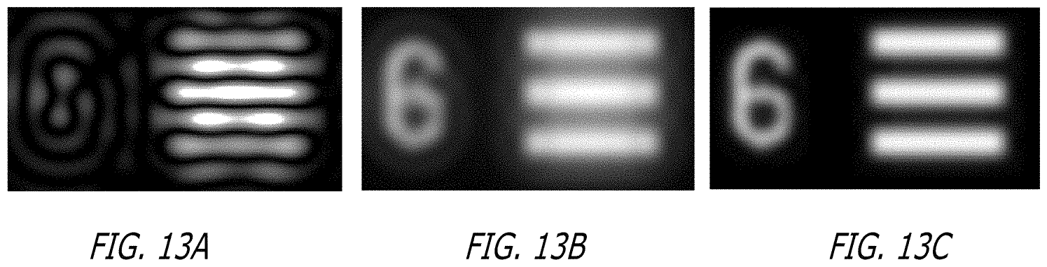

FIGS. 13A-13C show various images of a 0.2 μm tall section of a USAF target positioned at object plane of the imaging system shown in FIG. 8. FIG. 13A shows the images of the using coherent illumination, incoherent illumination, and the partially spatially coherent light produced using the mode scrambling system described above and shown in FIGS. 8 and 9. FIG. 13A shows the image of the target when illuminated with spatially coherent light. As shown, although the modulation transfer function is close to unity (as shown by the extremely high contrast) the excessive filtering the features of the target are distorted beyond recognition. Further, as shown in FIG. 13B, the resolution of the target illuminated with incoherent light is greater than that of the target illuminated with coherent light (see FIG. 13A). However, as evident in FIG. 13C, the overall contrast of the target image utilizing partially spatially coherent light is far superior to the target image using coherent and incoherent light (see FIGS. 13A and 13B) even when the design is diffraction-limited, as it is in the imaging system shown in FIG. 8.

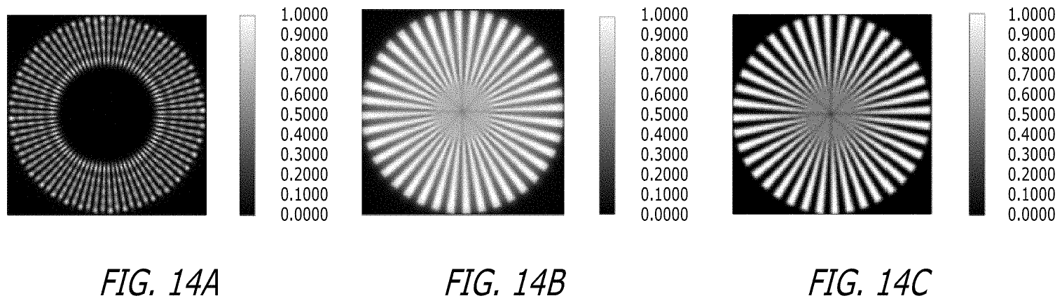

FIGS. 14A-14C show various images of a 40 pair per revolution spoke target of image height 0.5 mm corresponding to the imaging system shown in FIG. 8. Spoke targets are frequently used for quantifying contrast over a range of directions and spatial frequencies. Contrast along a given radius at the spoke target image corresponds directly to a measure of the modulation transfer function at a spatial frequency corresponding to 40 cycles per circumference (2pi times the radius, in millimeters). FIG. 14A shows the image of the spoke target when illuminated with spatially coherent light. As shown, the contrast suddenly disappears at a minimum radius corresponding to one-half of what is ordinarily considered the “cutoff” spatial frequency. In contrast, FIG. 14B shows the corresponding spoke target image with spatially incoherent illumination. FIG. 14C shows the corresponding spoke target image with partially spatially coherent illumination. As is evident, the overall contrast of the spoke target image utilizing partially spatially coherent illumination is far superior to the target image using coherent and incoherent light (See FIGS. 14A and 14B), even when the design is diffraction-limited, as it is in the imaging system shown in FIG. 8.

It is appreciated by persons skilled in the art that the present invention is not limited by what has been particularly shown and described hereinabove. Rather, the scope of the present invention includes both combinations and sub-combinations of various features described hereinabove as well as variations and modifications thereto which would occur to a person of skill in the art upon reading the above description and which are not in the prior art.

What is claimed:

1. A system for outputting partially spatially coherent light to an imaging system, comprising:
at least one spatially coherent light source configured to output at least one spatially coherent light source output signal;
at least one optical device having at last one optical device body;
a first device surface formed on the at least one optical device body and configured to reflect at least a portion of the at least one spatially coherent light source output signal to form at least one coherent reflected signal;
at least a second device surface formed on the at least one optical device body, the at least one second device surface having one or more surface irregularities formed thereon, the one or more surface irregularities configured to diffuse at least a portion of the at least one spatially coherent light source output signal transmitted through the optical device body to produce at least one spatially incoherent signal;
at least one reflective coating applied to the at least a second device surface and configured to reflect the at least one spatially incoherent signal from the at least a second device surface through the first device surface formed on the optical device body, wherein the combination of the at least one coherent reflected signal and the at least one spatially incoherent signal to form at least one partially spatially coherent light signal.

2. The system for outputting partially spatially coherent light to an imaging system of claim 1, wherein the optical device body is manufactured from silica-based glass.

3. The system for outputting partially coherent partially spatially coherent light to an imaging system of claim 1, wherein the optical device body is manufactured from at least one material selected from the group consisting of optical crystals, composite materials, and ceramic materials.

4. The system for outputting partially spatially coherent light to an imaging system of claim 1, further comprising at least one optical coating applied to the first device surface.

5. The system for outputting partially coherent partially spatially coherent light to an imaging system of claim 1, further comprising at least one optical coating applied to the at least a second device surface.

6. The system for outputting partially spatially coherent light to an imaging system of claim 1, further comprising at least one optical coating applied to at least one of the first device surface in the at least a second device surface.

7. The system for outputting partially spatially coherent light to an imaging system of claim 1, wherein the optical element is configured to be selectively rotated about an optical axis.

8. The system for outputting partially spatially coherent light to an imaging system of claim 1, further comprising at least one imaging system in optical communication with the system for outputting partially spatially coherent light, the at least one imaging system comprising a catoptric objective system.

9. The system for outputting partially spatially coherent light to an imaging system of claim 1, further comprising at least one imaging system in optical communication with the system for outputting partially spatially coherent light, the at least one imaging system comprising a catadioptric objective system.

10. An imaging system using partially spatially coherent light, comprising:
at least one spatially coherent light source configured to output at least one spatially coherent light source output signal;
at least one partially spatially coherent light system configured to receive the at least one spatially coherent light source output signal and transmit at least one partially spatially coherent light signal; and
at least one catoptric focusing/objective system in optical communication with the at least one partially spatially coherent light system, the at least one catoptric focusing/objective system configured to focus the at least one partially spatially coherent light signal to at least one focal point on a substrate.

11. The imaging system using partially spatially coherent light of claim 10, further comprising at least one optical fiber in communication with the at least one spatially coherent light source and the at least one partially spatially coherent light system, the at least one optical fiber configured to transmit the at least one spatially coherent light source output signal to the at least one partially spatially coherent light system.

12. The imaging system using partially spatially coherent light of claim 11, wherein the at least one optical fiber comprises a single mode fiber.

13. The imaging system using partially spatially coherent light of claim 11, wherein the at least one optical fiber comprises a multi-mode fiber.

14. The imaging system using partially spatially coherent light of claim 10, wherein the at least one partially spatially coherent light system comprises at least one optical device body having a first surface and at least a second surface, the second surface having at least one surface irregularity formed thereon and at least one optical coating applied thereto.

15. The imaging system using partially spatially coherent light of claim 10, wherein at least one optical device body is configured to be rotated about at least one optical axis.

16. The imaging system using partially spatially coherent light of claim 10, wherein the partially spatially coherent light system comprises at least one mode scrambling system having a first mode scrambling body and at least a second mode scrambling body formed therein.

17. The imaging system using partially spatially coherent light of claim 10, further comprising at least one autofocus module configured to transmit at least one autofocus signal, the at least one autofocus signal co-aligned with the at least one partially spatially coherent light signal.
